(19) United States
(12) Patent Application Publication
(10) Pub. No.: US 2025/0304123 A1
(43) Pub. Date: Oct. 2, 2025

(54) ACTIVE ADJUSTMENT METHOD, DEVICE, CONTROL SYSTEM AND CONTROL METHOD OF CONNECTING ROD LENGTH

(71) Applicant: Zhuzhou Times New Material Technology Co., Ltd., Hunan (CN)

(72) Inventors: Jun YANG, Hunan (CN); Lida WANG, Hunan (CN); Dingquan TANG, Hunan (CN); Guotao ZHA, Hunan (CN); Shaowen LIU, Hunan (CN); Qi ZHANG, Hunan (CN); Xiaohu WANG, Hunan (CN); Guanglin YANG, Hunan (CN); Canhui CHEN, Hunan (CN); Jun ZHOU, Hunan (CN)

(73) Assignee: Zhuzhou Times New Material Technology Co., Ltd., Hunan (CN)

(21) Appl. No.: 18/869,278

(22) PCT Filed: Aug. 4, 2023
(86) PCT No.: PCT/CN2023/111272

§ 371 Date: Nov. 26, 2024

(30) Foreign Application Priority Data
Aug. 16, 2022 (CN) 202210980737.9

(51) Int. Cl. B61F 5/24

(52) U.S. Cl. CPC B61F 5/24

(57) ABSTRACT

An active adjustment method of connecting rod length and an active adjustable connecting rod device, liquid medium is introduced into a first liquid cavity or a second liquid cavity, so that the piston is hydraulically driven to move, thereby realizing contraction of the connecting rod. The control system controls opening sizes and switching frequencies of the valves, to control extension or contraction speed of the connecting rod. To realize this method, design an active adjustable connecting rod device, which comprises two cylinders, a cylinder is connected with a rod body and a gas source by pipelines.

### TECHNICAL FIELD

The present invention relates to the technical field of railway vehicles, and particularly relates to an active adjustment method, device, control system and control method of connecting rod length.

### TECHNICAL BACKGROUND

With the continuous improvement of requirements for vehicle operating speed and riding comfort, the existing vehicle suspension system is difficult to satisfy the safety and comfort requirements when a train passes through a curve at high speed. A tilting train can enable a vehicle body to tilt before the train reaches the curve, and to balance the centrifugal force on the curve by its own gravity, so compared with the traditional railway transit vehicles, the tilting train can better solve the problems of safety and comfort when passing through the curve at high speed.

An anti-rolling torsion bar is used to prevent the rolling of the railway vehicles caused by passage through the curve, strong wind and bump to ensure driving safety. When the vehicle body is in the active tilting, the anti-rolling torsion bar will hinder the vehicle body from the active tilting. Thus, it is necessary to improve the anti-rolling torsion bar.

When the railway vehicle is driven on a straight route or a large curvature radius route, the anti-rolling torsion bar is required to provide a bidirectional anti-rolling torque to prevent the vehicle body from rolling; when the railway vehicle is driven on a small curvature radius route, the anti-rolling torsion bar is required to match with an air spring system to enable the vehicle body to tilt toward the inner side of the curve, which requires that the connecting rod length of the anti-rolling torsion bar can be adjusted in real time: when the railway vehicle is driven on a straight route or a large curvature radius route, the connecting rod length is required to keep unchanged; and when the railway vehicle is driven on a small curvature radius route, the connecting rod length is required to be extended or contracted with the tilting of the vehicle body. However, the connecting rod length of the traditional anti-rolling torsion bar is fixed during the operation of the vehicle and cannot be adjusted according to the operating state in real time. Meanwhile, considering factors such as cost, maintenance cost and technical difficulty, it is generally expected that only minor modifications can be made to the existing vehicles, so as to achieve the purpose of improving the curve operating speed of the vehicles.

The applicant has applied for three patents: a patent with the application number of “2022104672873” and the title of “an active adjustment method of connecting rod length and a hydraulic connecting rod”; a patent with the application number of “2022210235501” and the title of “a hydraulic connecting rod”; and a patent with the application number of “202210466160X” and the title of “an adjustable torsion bar system and an anti-rolling method”. In the three patents, the connecting rod is driven to be extended and contracted by an air spring, so as to realize free extension and contraction of the connecting rod.

According to patent search, the following patents are related to the present application: the following patents can realize active extension or contraction of the connecting rod, without the need to be driven by other components:
1. Chinese invention patent application with the application number of “CN202011125612.5”, the title of “a real-time active adjustment method of connecting rod length and an active anti-rolling torsion bar system” and the applicant of “Zhuzhou Times New Material Technology Co., Ltd.”. This invention can adjust the connecting rod length actively in real time according to the control instructions by installing an active adjustment device on the connecting rod, thus solving the defect that the length of the traditional connecting rod is fixed and unadjustable. The present invention further relates to an active anti-rolling torsion bar system, comprising: a connecting rod, a torsion bar and a supporting seat. The connecting rod is provided with a ball screw mechanism, which can adjust the length of the connecting rod rapidly in real time according to the control instructions, so that the torsion bar generates torsion deformation and then actively provides the anti-rolling torque for the vehicle body to realize the active adjustment of the rolling angle of the vehicle body, which helps to improve the speed and the safety of the train when passing through a curve, thereby increasing the operating speed of the train.
2. Chinese invention patent application with the application number of “CN202110155825.0”, the title of “an active tilting device” and the applicant of “CRRC Qingdao Sifang Rolling Stock Research Institute Co., Ltd.”, comprising: the active tilting device comprises: a first adjustable connecting rod, a second adjustable connecting rod, a first torsion arm, a second torsion arm, a first torsion bar, a second torsion bar, a first flange, a second flange, a third flange, a speed reducer, a motor and a sleeve support; the input end of the speed reducer is connected with the motor through the third flange, the sleeve support is connected to the housing of the speed reducer, and the motor is arranged in the sleeve support; the first flange is connected to the output end of the speed reducer, one end of the first torsion bar is in interference fit with the first flange, and the other end is in interference fit with the first torsion arm; the first adjustable connecting rod is connected with the first torsion arm through a spherical hinge; the second flange is fixedly connected with the sleeve support, one end of the second torsion bar is in interference fit with the second flange, and the other end is in interference fit with the second torsion arm; and the second adjustable connecting rod is connected with the second torsion arm through a spherical hinge.

The above two patent applications are to actively realize extension or contraction of the connecting rod by installing a motor, which means that an additional motor with very large power and size is needed in the steering system. Meanwhile, for the solution in which the motor is adopted, when the motor fails, the passive safety cannot be guaranteed.
3. Chinese invention patent application with the application number of “CN202110155835.4”, the title of “a single-arm dual-connecting rod anti-rolling torsion bar tilting device” and the applicant of “CRRC Qingdao Sifang Rolling Stock Research Institute Co., Ltd.”. In this invention patent application, an adjustable connecting rod and an actuator connecting rod are separately arranged by connecting the torsion arms. When a vehicle is driven on a straight route, the length of the actuator is freely extended or contracted with a second spherical hinge connecting node of the torsional arm; and when the vehicle enters a transition curve, the actuator connecting rod receives the control instructions from the control system to extend or contract and then drives the torsion arm to rotate around a first spherical hinge connecting node, thereby driving the torsion bar to twist to realize the tilting of the vehicle body. Specifically, the actuator connecting rod can be a hydraulic cylinder connecting rod or a ball screw.

In this patent application, an additional hydraulic pump system is needed in the anti-rolling torsion bar system to achieve the effect of active adjustment.

### SUMMARY OF THE INVENTION

The technical problem to be solved by the present invention is to provide an active adjustment method of connecting rod length, so that the connecting rod length can be actively converted between two states of length fixing and free extension and contraction in real time according to the needs of vehicle operation, and the control feedback is realized in combination with the control system.

An active adjustment method of connecting rod length, wherein the connecting rod comprises a rod body, a cavity body and a piston arranged in the cavity body, the cavity body is divided into a first liquid cavity and a second liquid cavity by the piston, the first liquid cavity and the second liquid cavity are filled with liquid media, one end of the rod body is fixed with the piston, and the other end is extended from the cavity body through the first liquid cavity. The liquid media are actively controlled to enter or flow out of the first liquid cavity or the second liquid cavity, so as to realize real-time active conversion of connecting rod length between the two states of length fixing and free extension and contraction.

Further, a liquid medium is introduced into the first liquid cavity, so that the piston is hydraulically driven to move to the second liquid cavity, and the liquid medium in the second liquid cavity is discharged, thereby realizing contraction of the rod body; a liquid medium is introduced into the second liquid cavity, so that the piston is hydraulically driven to move to the first liquid cavity, and the liquid medium in the first liquid cavity is discharged, thereby realizing extension of the rod body; and passages for introducing the liquid media into the first liquid cavity and the second liquid cavity are closed simultaneously, no liquid medium is discharged from the first liquid cavity and the second liquid cavity, and the connecting rod is in a state of length fixing due to incompressibility of the liquid media.

Further, the liquid medium is compressed by atmospheric pressure of gas, and the atmospheric pressure is converted to hydraulic pressure, so that the liquid medium enters the first liquid cavity or the second liquid cavity.

Further, the gas is the original high-pressure gas resource of the bogie system.

Furthermore, the on-off of the gas is controlled by valves, and the extension or contraction speed of the connecting rod is controlled by individual or combined control of the opening sizes or switching frequencies of valves adjusting the on-off of the gas in the system.

The present invention also provides an active adjustable connecting rod device. The connecting rod comprises a rod body, a cavity body and a piston arranged in the cavity body, the cavity body is divided into a first liquid cavity and a second liquid cavity by the piston, the first liquid cavity and the second liquid cavity are filled with liquid media, one end of the rod body is fixed with the piston, and the other end is extended from the cavity body through the first liquid cavity. The connecting rod also comprises two cylinders, the first liquid cavity and the second liquid cavity are respectively communicated with cylinders through pipelines, a floating piston is movably arranged in each cylinder, each cylinder is divided into two cavities by the floating piston, and one of the cavities contains a liquid medium which is communicated with the cavity body; and the movement of the floating piston causes the liquid medium to enter or flow out of the first liquid cavity or the second liquid cavity.

Further, each cylinder is divided into a liquid cavity and a gas source cavity by the floating piston, the gas source cavity is communicated with a gas source, and the liquid cavity is communicated with the cavity body; gas is introduced into the gas source cavity, and the floating piston is driven by the gas to compress the liquid medium in the liquid cavity, so that the liquid medium in the liquid cavity enters the cavity body through a pipeline to drive the piston to move; and the pipelines communicating the first liquid cavity and the second liquid cavity with the cylinders are provided with valves A to adjust the on-off of the pipelines.

The cylinder communicated with the first liquid cavity is called first cylinder, the corresponding floating piston in the first cylinder is called first floating piston, the pipeline connecting the first liquid cavity with the first cylinder is called first pipeline, and the valve A on the first pipeline is called first valve. The cylinder communicated with the second liquid cavity is called second cylinder, the corresponding floating piston in the second cylinder is called second floating piston, the pipeline connecting the second liquid cavity with the second cylinder is called second pipeline, and the valve A on the second pipeline is called second valve.

The contraction of the rod body is realized as follows: a liquid medium is introduced into the first liquid cavity, so that the piston is hydraulically driven to move to the second liquid cavity, and the liquid medium in the second liquid cavity is discharged, thereby realizing contraction of the rod body. When the active adjustable connecting rod device is specifically used, the process is as follows: the first valve and the second valve are opened, gas is introduced into the gas source cavity of the first cylinder, the first floating piston is compressed and driven by the gas to press the liquid medium in the liquid cavity of the first cylinder into the first liquid cavity, and the piston is driven by the liquid medium in the first liquid cavity to move to the second liquid cavity so that the liquid medium in the second liquid cavity is discharged into the second cylinder, thereby realizing contraction of the rod body.

The extension of the rod body is realized as follows: a liquid medium is introduced into the second liquid cavity, so that the piston is hydraulically driven to move to the first liquid cavity, and the liquid medium in the first liquid cavity is discharged, thereby realizing extension of the rod body. When the active adjustable connecting rod device is specifically used, the process is as follows: the first valve and the second valve are opened, gas is introduced into the gas source cavity of the second cylinder, the second floating piston is compressed and driven by the gas to press the liquid medium in the liquid cavity of the second cylinder into the second liquid cavity, and the piston is driven by the liquid medium in the second liquid cavity to move to the first liquid cavity so that the liquid medium in the first liquid cavity is discharged into the first cylinder, thereby realizing extension of the rod body.

The length fixing of the connecting rod is realized as follows: the passages for introducing the liquid media into the first liquid cavity and the second liquid cavity are closed simultaneously, and the connecting rod is in a state of length fixing due to incompressibility of the liquid media. The length fixing of the connecting rod comprises length fixing of the connecting rod in the initial position and length fixing of the connecting rod after extension and contraction. When the active adjustable connecting rod device is specifically used, the process is as follows: the first valve and the second valve are closed, and due to incompressibility of the liquid media, the rod body is not affected by the outside world and is always in a state of length fixing regardless of whether the rod body of the connecting rod is in tension or under pressure.

The extension and contraction as well as length fixing of the connecting rod in the present invention are actually the extension and contraction as well as length fixing of the rod body in terms of the structure of the active adjustable connecting rod device.

Furthermore, to enable the floating piston to move smoothly, the gas source cavity is provided with a vent hole, and a valve B is installed at the vent hole. When the liquid medium in the cavity body is pressed into the cylinder, the valve B on the cylinder is opened, the gas source cavity is communicated with the atmospheric pressure, and the floating piston in the cylinder is driven by the liquid medium flowing out of the cavity body to move.

When gas is introduced into the first cylinder, the valve B (called third valve) of the first cylinder is closed, and the valve B (called fourth valve) of the second cylinder is opened. When gas is introduced into the second cylinder, the valve B of the second cylinder is closed, and the valve B of the first cylinder is opened.

Furthermore, the gas source cavity is communicated with the original high-pressure gas source of the bogie system through a pipeline, and the pipeline is provided with a valve C which is a one-way valve. The present invention makes full use of the original high-pressure gas resource of the bogie system, so that the active adjustable connecting rod device of the present invention has simple structure, and only minor modifications are made to the connecting rod to guarantee the anti-rolling safety of the vehicles.

Further, the valves A, the valves B and the valve C are switching valves or proportional valves.

Further, the valves A, the valves B and the valve C are solenoid valves. Automatic control can only be achieved using solenoid valves.

Further, a first sealing ring is installed at the contact point between the piston and the cavity body, and a second sealing ring is installed at the contact point between the floating piston and the cylinder. The first sealing ring ensures that the cavity body is divided into the first liquid cavity and the second liquid cavity by the piston and the liquid media in the first liquid cavity and the second liquid cavity will not leak, and also ensures that when the piston is moving, the liquid medium in the first liquid cavity will not enter the second liquid cavity and the liquid medium in the second liquid cavity will not enter the first liquid cavity.

Further, the pipelines communicating the first liquid cavity and the second liquid cavity with the cylinders are also provided with mass flow meters.

Further, the connecting rod is provided with a height sensor or a speed sensor.

The present invention also provides a control system, which is used for controlling the above active adjustable connecting rod device, comprising:

A perception system, used for collecting state information of the connecting rod in real time;

A decision making system, used for storing and feeding back the state information and running a preset program to drive the opening sizes or switching frequencies of the valves controlling the extension and contraction of the connecting rod;

An execution system, which is the above active adjustable connecting rod device.

Further, the decision making system comprises ECU hardware and a control program loaded thereon, and the ECU hardware comprises a communication module, a processor module, a storage module, a drive module and a signal collection module;

The communication module is used for two-way communication with a host computer;

The processor module is used for running the control program;

The storage module is used for storing the control program, data of the perception system and communication information;

The drive module is used for driving each valve of the active adjustable connecting rod device;

The signal collection module is used for collecting and feeding back signals of the perception system.

Further, the perception system includes but is not limited to a height sensor and mass flow meters.

The present invention also provides a control method, which is used for controlling connecting rod length using the above control system, comprising the following steps:
(1) The host computer gives connecting rod adjustment instructions to the decision making system;
(2) The decision making system runs a preset program to drive the opening sizes or switching frequencies of the valves of the execution system;
(3) The state of the connecting rod of the execution system is changed;
(4) The perception system collects and transmits the real-time state of the connecting rod to the decision making system;
(5) The decision making system judges whether the connecting rod has reached the established extension or contraction target, if yes, the adjustment is ended, if not, the steps (2) to (5) are repeated until the established target is reached.

Further, the decision making system comprises ECU hardware and a control program loaded thereon, and the ECU hardware comprises a communication module, a processor module, a storage module, a drive module and a signal collection module;

The communication module is used for two-way communication with a host computer;

The processor module is used for running the control program;

The storage module is used for storing the control program, data of the perception system and communication information;

The drive module is used for driving each valve of the active adjustable connecting rod device;

The signal collection module is used for collecting and feeding back signals of the perception system;

Comprising the following steps:
(1) The communication module of the decision making system receives three states of extension, contraction and length fixing of the connecting rod as well as the extension or contraction speed and speed information instructions of the connecting rod from the host computer;
(2) The processor module runs an established program stored in the storage module and decomposes the instructions from the host computer into on-off, opening sizes and switching frequencies of the valves;
(3) The valves are driven by the drive module to work, and the state of the connecting rod is changed;
(4) The perception system collects the real-time state of the connecting rod, and the signal collection module collects the data of the perception system and feeds back signals of the perception system to the processor module;
(5) The processor module judges whether the connecting rod has reached the established extension or contraction target, if yes, the adjustment is ended, if not, the steps (2) to (5) are repeated until the established target is reached.

Further, the perception system directly measures the change of connecting rod length through the height sensor arranged on the cavity body.

Further, the perception system measures the mass flow of the liquid passing through the pipelines using the mass flow meters, and due to incompressibility of the liquid, the change of connecting rod length is calculated by the mass flow meters arranged in the storage module in advance and the calculation model for connecting rod length according to the data measured by the mass flow meters.

Furthermore, the perception system comprises a height sensor and mass flow meters, the height sensor directly measures the change of connecting rod length, the mass flow meters measure the mass flow of the liquid passing through the pipelines, and due to incompressibility of the liquid, the change of connecting rod length is calculated by the mass flow meters arranged in the storage module in advance and the calculation model for connecting rod length according to the data measured by the mass flow meters. The information on the change of connecting rod length is obtained in two manners.

Further, the change of connecting rod length is directly measured by the height sensor, and the change of connecting rod length is calculated by the mass flow meters arranged in the storage module in advance and the calculation model for connecting rod length according to the data of the mass flow meters; the processor module compares the data of the change of connecting rod length calculated by the mass flow meters with the data of the change of connecting rod length directly measured by the height sensor, and monitors the fullness of the liquid medium in the active device; and if the difference between the two sets of data is greater than the preset threshold 4, it is considered that liquid leakage has occurred, and an ECU sends an alarm message to the host computer.

The present invention has the following beneficial effects:

The active adjustment method of connecting rod length of the present invention realizes the active control on extension and contraction of the connecting rod, specifically: the cavity body is divided into a first liquid cavity and a second liquid cavity by the piston, and atmospheric pressure is converted to hydraulic pressure by the original high-pressure gas source of the bogie system to drive the piston to move in the cavity body to realize contraction and extension of the rod body. When the passages for introducing the liquid media into the first liquid cavity and the second liquid cavity are closed simultaneously, the connecting rod is in a state of length fixing due to incompressibility of the liquid media. The on-off the passages for introducing the liquid media into the first liquid cavity and the second liquid cavity is actively controlled by the control system.

The active adjustable connecting rod device of the present invention is provided with power by the original gas resource of the bogie system, which reduces power units and greatly simplifies the structure compared with the prior art; and the power is driven by the cylinders and atmospheric pressure, the volume of each cylinder is not large, and the arrangement of the components such as cylinders and pipelines does not require changes to the original connecting rod. After the cylinders are installed, the gas source can be communicated with the first liquid cavity (the second liquid cavity) directly through the pipeline.

The active adjustable connecting rod device is combined with the control system: the connecting rod length can be actively converted between the two states of length fixing and free extension and contraction in real time according to the needs of vehicle operation.
1. Automatic feedback control is realized by the sensor: the height sensor of the perception system directly measures the extension or contraction length of the connecting rod. Meanwhile, the mass flow meters measure the mass flow of the liquid entering the first liquid cavity (the second liquid cavity), and the change of rod body length is calculated by the mass flow meters in the storage module and the calculation model for connecting rod length, which can be used as a supplementary means to measure connecting rod length.
2. The fullness of the liquid medium in the active device can be monitored to judge whether liquid leakage has occurred, and the ECU sends an alarm message to the host computer. The height sensor of the perception system directly measures the extension or contraction length of the connecting rod. Meanwhile, the mass flow meters measure the mass flow data of the liquid entering the first liquid cavity (the second liquid cavity), and the change of connecting rod length is calculated by the mass flow meters in the storage module and the calculation model for connecting rod length. The change of connecting rod length obtained in this manner is compared with the data of connecting rod length measured by the height sensor to monitor the fullness of the liquid medium in the active device. If the difference between the two sets of data is greater than the preset threshold Δ, it is considered that liquid leakage has occurred, and the ECU sends an alarm message to the host computer.
3. The perception system of the present invention also can be used for monitoring false alarms of the sensor. In the second point above, if the ECU sends an alarm message to the host computer, but no liquid leakage occurs, then the sensor has a false alarm.

### DESCRIPTION OF THE DRAWINGS

FIG. 1 is a structural schematic diagram of an active adjustable connecting rod device.

FIG. 2 is a schematic diagram of a control system.

FIG. 3 is a flow chart (I) of a control system.

FIG. 4 is a flow chart (II) of a control system.

FIG. 5 is a flow chart of liquid leakage detection.

In the figures: 1—first spherical hinge, 2—rod body, 3—first sealing ring, 41—first liquid cavity, 42—second liquid cavity, 5—second spherical hinge, 6—first valve, 7—second valve, 8—first cylinder, 9—second cylinder, 10—first floating piston, 11—second floating piston, 12—third valve, 13—fourth valve, 14—fifth valve, 15—sixth valve, 16—high-pressure gas source, 17—sealing ring A, 18—sealing ring B, 19—liquid cavity, 20—gas source cavity, 21—first mass flow meter, 22—second mass flow meter, and 23—piston.

### DETAILED DESCRIPTION OF THE EMBODIMENTS

The present invention is further described below through specific embodiments in combination with drawings.

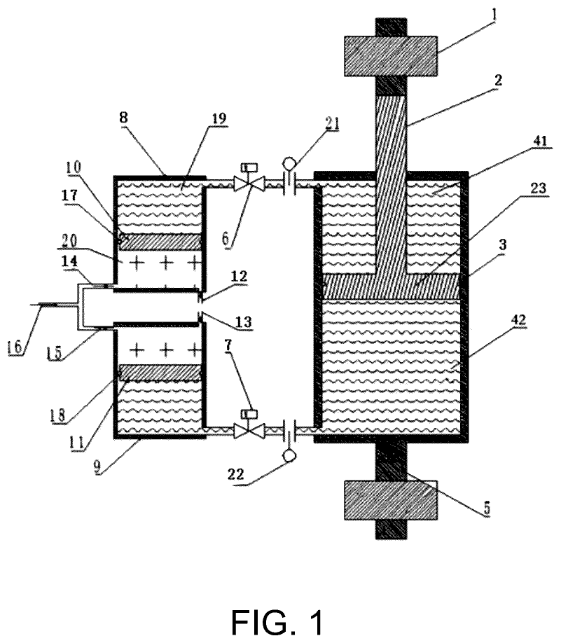

As shown in FIG. 1, the connecting rod comprises a rod body 2, a cavity body and a piston 23, the piston 23 is movably arranged in the cavity body, the cavity body is divided into a first liquid cavity 41 and a second liquid cavity 42 by the piston 23, and the first liquid cavity 41 and the second liquid cavity 42 are filled with liquid media; and one end of the rod body 2 is fixed with the piston 23, and the other end is extended from the cavity body through the first liquid cavity 41.

As described in the background, the applicant has applied for three patents: a patent with the application number of “2022104672873” and the title of “an active adjustment method of connecting rod length and a hydraulic connecting rod”; a patent with the application number of “2022210235501” and the title of “a hydraulic connecting rod”; and a patent with the application number of “202210466160X” and the title of “an adjustable torsion bar system and an anti-rolling method”. In the three patents, the tilting of the vehicle body keeps the connecting rod under pressure or in tension, and although the extension and contraction of the connecting rod is free, the extension and contraction of the connecting rod is driven by the tilting of the vehicle body, that is follow-up. The automatic control in these patents is to control the on-off of the valves, so that the connecting rod can be freely extended or contracted with the tilting of the vehicle body or is fixed in length. The extension length of the connecting rod is determined by the tilting angle of the vehicle body, but not controlled by the control system.

The active adjustment of the connecting rod in the present application refers to that the length of the connecting rod is actively adjusted by the control system, not driven by the tilting of the vehicle body, and is independent, not affected by other components of the vehicle body.

The specific method is as follows: the control system actively controls the liquid medium to enter or flow out of the first liquid cavity or the second liquid cavity, so as to realize real-time active conversion of connecting rod length between the two states of length fixing and free extension and contraction.

The method is realized by the active adjustable connecting rod device and the control system.

The active adjustable connecting rod device, as shown in FIG. 1, comprises the connecting rod, and also comprises two cylinders, the first liquid cavity 41 and the second liquid cavity 42 are respectively communicated with cylinders through pipelines, a floating piston is movably arranged in each cylinder, each cylinder is divided into a liquid cavity 19 and a gas source cavity 20 by the floating piston, the gas source cavity 20 is communicated with a gas source, and the liquid cavity 19 is communicated with the cavity body; gas is introduced into the gas source cavity 20, and the floating piston is driven by the gas to compress the liquid medium in the liquid cavity 19, so that the liquid medium in the liquid cavity 19 enters the cavity body through a pipeline to drive the piston 23 to move; and the pipelines communicating the first liquid cavity 41 and the second liquid cavity 42 with the cylinders are provided with valves A to adjust the on-off of the pipelines.

The cylinder communicated with the first liquid cavity 41 is called first cylinder 8, the corresponding floating piston in the first cylinder 8 is called first floating piston 10, the pipeline connecting the first liquid cavity 41 with the first cylinder 8 is called first pipeline, and the valve A on the first pipeline is called first valve 6. The cylinder communicated with the second liquid cavity 42 is called second cylinder 9, the corresponding floating piston in the second cylinder 9 is called second floating piston 11, the pipeline connecting the second liquid cavity 42 with the second cylinder 9 is called second pipeline, and the valve A on the second pipeline is called second valve 7.

To enable the floating piston to move smoothly, the gas source cavity 20 is provided with a vent hole, and a valve B is installed at the vent hole. When the liquid medium in the cavity body is pressed into the cylinder, the valve B on the cylinder is opened, the gas source cavity 20 is communicated with the atmospheric pressure, and the floating piston in the cylinder is driven by the liquid medium flowing out of the cavity body to move.

The valve B at the vent hole in the first cylinder 8 is called third valve 12, and the valve B at the vent hole in the second cylinder 9 is called fourth valve 13.

The gas source cavity 20 is communicated with the original high-pressure gas source 16 of the bogie system through a pipeline, and the pipeline is provided with a valve C which is a one-way valve. The present invention makes full use of the original high-pressure gas resource of the bogie system, so that the active adjustable connecting rod device of the present invention has simple structure, and only minor modifications are made to the connecting rod to guarantee the anti-rolling safety of the vehicles.

The valve C on the pipeline communicating the gas source with the first cylinder 8 is called fifth valve 14, and the valve C on the pipeline communicating the gas source with the second cylinder 9 is called sixth valve 15.

A first sealing ring 3 is installed at the contact point between the piston 23 and the cavity body, and a second sealing ring (i.e., a sealing ring A or a sealing ring B) is installed at the contact point between the floating piston and the cylinder.

The pipelines communicating the first liquid cavity 41 and the second liquid cavity 42 with the cylinders are also provided with mass flow meters.

The connecting rod is provided with a height sensor. The present application comprises one height sensor and two mass flow meters, and the height sensor is installed on the rod body 2. As shown in FIG. 1, the two mass flow meters are respectively installed on the pipeline communicating the first liquid cavity 41 with the first cylinder 8 and the pipeline communicating the second liquid cavity 42 with the second cylinder 9.

The first valve 6 and the second valve 7 are in a normally closed state when out of control, and at this moment, the connecting rod is in a state of length fixing, which is used to guarantee passive safety when the control system fails.

The active adjustable connecting rod device of the present embodiment is provided with motive power by the original high-pressure gas resource of the bogie system. On the basis of the original connecting rod, the cylinders are added, the cylinders, the high-pressure gas source 16 and the original cavity body are communicated through pipelines, and the atmospheric pressure of the high-pressure gas source 16 is converted to the hydraulic pressure in the cylinders first and finally to two states of extension and contraction and fixing of connecting rod length through the active adjustable connecting rod device. The present application is simple in structure, the existing structure is used without the need of improving the original connecting rod structure, and only the cylinders (the first cylinder 8 and the second cylinder 9) which are not large in volume are added, thereby realizing light weight. As described in the background, a motor and a hydraulic pump system are needed to provide power in the prior art and then to drive the rod body 2 of the connecting rod to extend and contract in combination with a transmission structure, and power units and transmission components are needed to be installed, which occupies a large volume. The present application is provided with power by the original gas resource of the bogie system, which reduces power units and greatly simplifies the structure compared with the prior art; and the power is driven by the cylinders and atmospheric pressure, the volume of each cylinder is not large, and the arrangement of the components such as cylinders and pipelines does not require changes to the original connecting rod. After the cylinders are installed, the gas source can be communicated with the first liquid cavity 41 (the second liquid cavity 42) directly through the pipeline.

The contraction of the rod body 2 is realized as follows: a liquid medium is introduced into the first liquid cavity 41, so that the piston 23 is hydraulically driven to move to the second liquid cavity 42, and the liquid medium in the second liquid cavity 42 is discharged, thereby realizing contraction of the rod body 2. When the active adjustable connecting rod device is specifically used, the process is as follows: as shown in FIG. 1, the fifth valve 14, the first valve 6, the second valve 7 and the fourth valve 13 are opened, the third valve 12 and the sixth valve 15 are closed, and gas is introduced into the gas source cavity 20 of the first cylinder 8; because the third valve 12 is closed and the fifth valve 14 is a one-way valve, due to the sealing function of the second sealing ring in the first cylinder 8, the gas entering the gas source cavity 20 of the first cylinder 8 will not leak; and the first floating piston 10 is compressed and driven by the gas so that the first floating piston 10 moves up to press the liquid medium in the liquid cavity 19 of the first cylinder 8 into the first liquid cavity 41. In addition, due to the sealing function of the first sealing ring 3 in the cavity body, the liquid medium in the first liquid cavity 41 will not enter the second liquid cavity 42; when the first liquid cavity 41 is filled with the liquid medium, the liquid medium in the first liquid cavity 41 drives the piston 23 to move down (that is, to the second liquid cavity 42), so that the liquid medium in the second liquid cavity 42 is discharged into the second cylinder 9, thereby realizing contraction of the rod body 2; and meanwhile, since the fourth valve 13 is opened at this moment, the liquid discharged into the second cylinder 9 drives the second floating piston 11 to move up.

The extension of the rod body 2 is realized as follows: a liquid medium is introduced into the second liquid cavity 42, so that the piston 23 is hydraulically driven to move to the first liquid cavity 41, and the liquid medium in the first liquid cavity 41 is discharged, thereby realizing extension of the rod body 2. When the active adjustable connecting rod device is specifically used, the process is as follows: as shown in FIG. 1, the sixth valve 15, the second valve 7, the first valve 6 and the third valve 12 are opened, the fourth valve 13 and the fifth valve 14 are closed, and gas is introduced into the gas source cavity 20 of the second cylinder 9; because the fourth valve 13 is closed and the sixth valve 15 is a one-way valve, due to the sealing function of the second sealing ring in the second cylinder 9, the gas entering the gas source cavity 20 of the second cylinder 9 will not leak; and the second floating piston 11 in the second cylinder 9 is compressed by the gas so that the second floating piston 11 moves down to press the liquid medium in the liquid cavity 19 of the second cylinder 9 into the second liquid cavity 42. In addition, due to the sealing function of the first sealing ring 3 in the cavity body, the liquid medium in the second liquid cavity 42 will not enter the first liquid cavity 41; when the second liquid cavity 42 is filled with the liquid medium, the liquid medium in the second liquid cavity 42 drives the piston 23 to move up (that is, to the first liquid cavity 41), so that the liquid medium in the first liquid cavity 41 is discharged into the first cylinder 8, thereby realizing extension of the rod body 2; and meanwhile, since the third valve 12 is opened at this moment, the liquid discharged into the first cylinder 8 drives the first floating piston 10 to move down.

The length fixing of the connecting rod is realized as follows: the passages for introducing the liquid media into the first liquid cavity 41 and the second liquid cavity 42 are closed simultaneously, and the connecting rod is in a state of length fixing due to incompressibility of the liquid media. The length fixing of the connecting rod comprises length fixing of the connecting rod in the initial position and length fixing of the connecting rod after extension and contraction. When the active adjustable connecting rod device is specifically used, the process is as follows: the first valve 6 and the second valve 7 are closed, and due to incompressibility of the liquid media, the rod body 2 is not affected by the outside world and is always in a state of length fixing regardless of whether the rod body 2 of the connecting rod is in tension or under pressure.

To realize automatic control, the first valve 6, the second valve 7, the third valve 12, the fourth valve 13, the fifth valve 14 and the sixth valve 15 are all solenoid valves, which can be switching valves or proportional valves, and the types of the valves will only affect the specific control program scheme, but will not affect the functions of the device. The first valve 6 and the second valve 7 are two-way solenoid valves, and the third valve 12, the fourth valve 13, the fifth valve 14 and the sixth valve 15 are one-way solenoid valves.

The extension or contraction speed of the connecting rod is controlled by individual or combined control of the opening sizes or switching frequencies of valves adjusting the on-off of the gas in the system.

For example:

When the fifth valve 14 is a proportional valve, the gas intake is controlled by controlling the opening size of the fifth valve 14, so as to achieve the purpose of controlling the contraction speed of the rod body 2. When the sixth valve 15 is a proportional valve, the gas intake is controlled by controlling the opening size of the sixth valve 15, so as to achieve the purpose of controlling the extension speed of the rod body 2.

When the fifth valve 14 is a switching valve, the gas intake is controlled by controlling the switching frequency of the fifth valve 14, so as to achieve the purpose of controlling the contraction speed of the rod body 2. When the sixth valve 15 is a switching valve, the gas intake is controlled by controlling the switching frequency of the sixth valve 15, so as to achieve the purpose of controlling the extension speed of the rod body 2.

The above-mentioned control system comprises:

A perception system, used for collecting state information of the connecting rod in real time;

A decision making system, used for storing and feeding back the state information and running a preset program to drive the opening sizes or switching frequencies of the valves controlling the extension and contraction of the connecting rod;

An execution system, which is the above active adjustable connecting rod device.

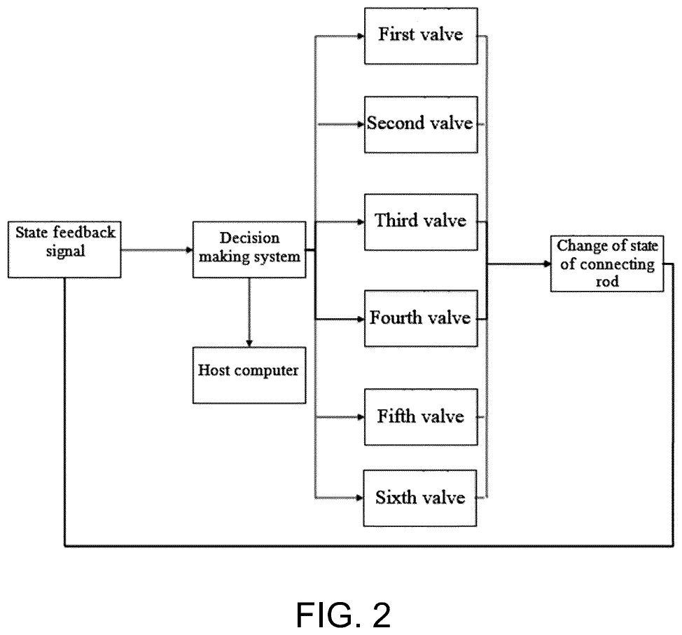

FIG. 2 shows a control schematic diagram.

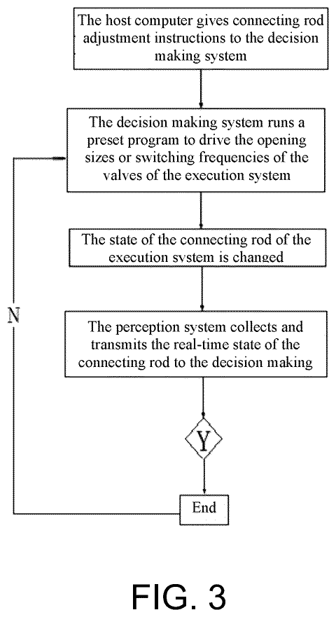

FIG. 3 shows a flow chart of the control system.
(1) The host computer gives connecting rod adjustment instructions to the decision making system;
(2) The decision making system runs a preset program to drive the opening sizes or switching frequencies of the valves (comprising the first valve 6, the second valve 7, the third valve 12, the fourth valve 13, the fifth valve 14 and the sixth valve 15) of the execution system;
(3) The state of the connecting rod of the execution system is changed;
(4) The perception system collects and transmits the real-time state of the connecting rod to the decision making system;
(5) The decision making system judges whether the connecting rod has reached the established extension or contraction target, if yes, the adjustment is ended, if not, the steps (2) to (5) are repeated until the established target is reached.

The decision making system comprises ECU hardware and a control program loaded thereon, and the ECU hardware comprises a communication module, a processor module, a storage module, a drive module and a signal collection module;

The communication module is used for two-way communication with a host computer;

The processor module is used for running the control program;

The storage module is used for storing the control program, data of the perception system and communication information;

The drive module is used for driving each valve of the active adjustable connecting rod device;

The signal collection module is used for collecting and feeding back signals of the perception system.

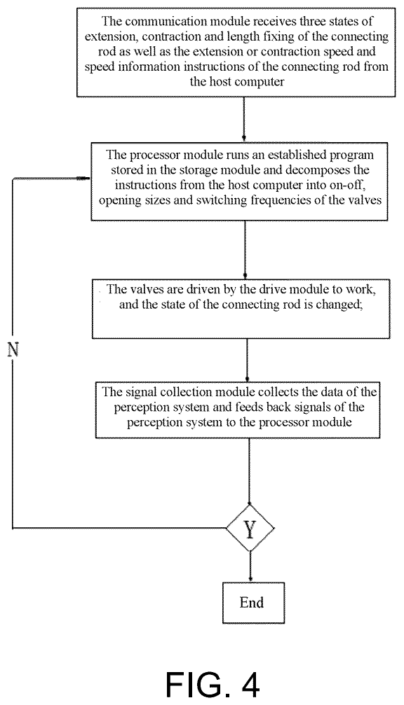

The specific control steps are as follows, as shown in the flow chart in FIG. 4:
(1) The communication module of the decision making system receives three states of extension, contraction and length fixing of the connecting rod as well as the extension or contraction speed and speed information instructions of the connecting rod from the host computer;
(2) The processor module runs an established program stored in the storage module and decomposes the instructions from the host computer into on-off, opening sizes and switching frequencies of the valves (comprising the first valve 6, the second valve 7, the third valve 12, the fourth valve 13, the fifth valve 14 and the sixth valve 15);
(3) The valves are driven by the drive module to work, and the state of the connecting rod is changed;
(4) The perception system collects the real-time state of the connecting rod, and the signal collection module collects the data of the perception system and feeds back signals of the perception system to the processor module;
(5) The processor module judges whether the connecting rod has reached the established extension or contraction target, if yes, the adjustment is ended, if not, the steps (2) to (5) are repeated until the established target is reached.

The above-mentioned host computer refers to a complete vehicle system, the control system in the present embodiment belongs to a subsystem, the complete vehicle system is a higher level of control system, and those skilled in the art know that in the control system, the subsystem must exchange information with a higher level of main system.

The perception system of the present embodiment comprises a height sensor and mass flow meters.

The height sensor directly measures the change of connecting rod length, the mass flow meters measure the mass flow of the liquid passing through the pipelines, and due to incompressibility of the liquid, the change of connecting rod length is calculated by the mass flow meters arranged in the storage module in advance and the calculation model for connecting rod length according to the data measured by the mass flow meters. The data of the change of connecting rod length are obtained in two manners, which are used for mutual check of height data.

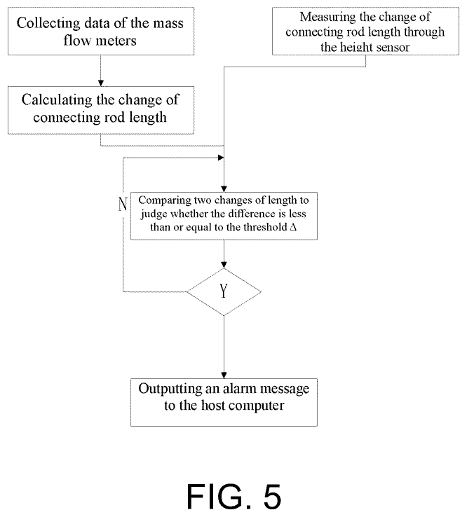

As shown in the flow chart in FIG. 5, the change of connecting rod length is directly measured by the height sensor, and the change of connecting rod length is calculated by the mass flow meters arranged in the storage module in advance and the calculation model for connecting rod length according to the data of the mass flow meters; the processor module compares the data of the change of connecting rod length calculated by the mass flow meters with the data of the change of connecting rod length directly measured by the height sensor, and monitors the fullness of the liquid medium in the active device; and if the difference between the two sets of data is greater than the preset threshold Δ, it is considered that liquid leakage has occurred, and an ECU sends an alarm message to the host computer.

If the difference between the two sets of data is greater than the preset threshold Δ, and no liquid leakage occurs, then the sensor fails and has a false alarm.

The above embodiments are merely used for illustration of the present invention, and not intended to limit the present invention. Various changes or transformations can also be made by those skilled in the art without departing from the spirit and the scope of the present invention. Therefore, all equivalent technical solutions shall also belong to the protection scope of the present invention, and the protection scope of the present invention shall be defined by the claims.

1. An active adjustment method of a connecting rod length, wherein a connecting rod comprises a rod member, a rod body and a piston arranged in the rod body, the rod body is divided into a first liquid cavity and a second liquid cavity by the piston, the first liquid cavity and the second liquid cavity are filled with liquid media, one end of the rod member is fixed with the piston, and an other end is extended from the rod body through the first liquid cavity; wherein the liquid media are actively controlled to enter or flow out of the first liquid cavity or the second liquid cavity, so as to realize real-time active conversion of the connecting rod length between two states of a length fixing and a free extension and contraction.

2. The active adjustment method of the connecting rod length according to claim 1, wherein a liquid medium is introduced into the first liquid cavity, so that the piston is hydraulically driven to move to the second liquid cavity, and the liquid medium in the second liquid cavity is discharged, thereby realizing contraction of the rod member; a liquid medium is introduced into the second liquid cavity, so that the piston is hydraulically driven to move to the first liquid cavity, and the liquid medium in the first liquid cavity is discharged, thereby realizing extension of the rod member; and passages for introducing the liquid media into the first liquid cavity and the second liquid cavity are closed simultaneously, no liquid medium is discharged from the first liquid cavity and the second liquid cavity, and the connecting rod is in a state of the length fixing due to incompressibility of the liquid media.

3. The active adjustment method of the connecting rod length according to claim 1, wherein a liquid medium is compressed by atmospheric pressure of gas, and the atmospheric pressure is converted to hydraulic pressure, so that the liquid medium enters the first liquid cavity or the second liquid cavity.

4. The active adjustment method of the connecting rod length according to claim 3, wherein the gas is an original high-pressure gas resource of a bogie system.

5. The active adjustment method of the connecting rod length according to claim 3, wherein an on-off of the gas is controlled by valves, and an extension or contraction speed of the connecting rod is controlled by individual or combined control of opening sizes or switching frequencies of valves adjusting the on-off of the gas in a system.

6. An active adjustable connecting rod device, a connecting rod comprises a rod member, a rod body and a piston arranged in the rod body, the rod body is divided into a first liquid cavity and a second liquid cavity by the piston, the first liquid cavity and the second liquid cavity are filled with liquid media, one end of the rod member is fixed with the piston, and an other end is extended from the rod body through the first liquid cavity; wherein the connecting rod also comprises two cylinders, the first liquid cavity and the second liquid cavity are respectively communicated with the cylinders through pipelines, a floating piston is movably arranged in each the cylinder, each the cylinder is divided into two cavities by the floating piston, and one of the cavities contains a liquid medium which is communicated with the rod body; and a movement of the floating piston causes the liquid medium to enter or flow out of the first liquid cavity or the second liquid cavity.

7. The active adjustable connecting rod device according to claim 6, wherein each the cylinder is divided into a liquid cavity and a gas source cavity by the floating piston, the gas source cavity is communicated with a gas source, and the liquid cavity is communicated with the rod body; gas is introduced into the gas source cavity, and the floating piston is driven by the gas to compress the liquid medium in the liquid cavity, so that the liquid medium in the liquid cavity enters the rod body through the pipeline to drive the piston to move; and the pipelines communicating the first liquid cavity and the second liquid cavity with the cylinders are provided with valves A to adjust an on-off of the pipelines.

8. The active adjustable connecting rod device according to claim 7, wherein the gas source cavity is provided with a vent hole, and a valve B is installed at the vent hole; when the liquid medium in the rod body is pressed into the cylinder, the valve B on the cylinder is opened, the gas source cavity is communicated with atmospheric pressure, and the floating piston in the cylinder is driven by the liquid medium flowing out of the rod body to move.

9. The active adjustable connecting rod device according to claim 8, wherein the gas source cavity is communicated with an original high-pressure gas source of a bogie system through the pipeline, and the pipeline is provided with a valve C which is a one-way valve.

10. The active adjustable connecting rod device according to claim 9, wherein the valves A, the valve B and the valve C are switching valves or proportional valves.

11. A control system, which is used for controlling the active adjustable connecting rod device according to claim 6, wherein comprising:
a perception system, used for collecting state information of the connecting rod in real time;
a decision making system, used for storing and feeding back the state information and running a preset program to drive opening sizes or switching frequencies of valves controlling an extension and contraction of the connecting rod; and
an execution system, which is the active adjustable connecting rod device.

12. The control system according to claim 11, wherein the decision making system comprises an ECU hardware and a control program loaded thereon, and the ECU hardware comprises a communication module, a processor module, a storage module, a drive module and a signal collection module;
the communication module is used for two-way communication with a host computer;
the processor module is used for running the control program;
the storage module is used for storing the control program, data of the perception system and communication information;
the drive module is used for driving each the valve of the active adjustable connecting rod device; and
the signal collection module is used for collecting and feeding back signals of the perception system.

13. The control system according to claim 11, wherein the perception system includes but is not limited to a height sensor and mass flow meters.

14. A control method, which is used for controlling a connecting rod length using the control system of claim 11, comprising the following steps:
(1) A host computer gives connecting rod adjustment instructions to the decision making system;
(2) The decision making system runs the preset program to drive the opening sizes or the switching frequencies of the valves of the execution system;
(3) A state of the connecting rod of the execution system is changed;
(4) The perception system collects and transmits a real-time state of the connecting rod to the decision making system; and
(5) The decision making system judges whether the connecting rod has reached a established extension or contraction target, if yes, an adjustment is ended, if not, the steps (2) to (5) are repeated until an established target is reached.

15. The control method according to claim 14, wherein the decision making system comprises an ECU hardware and a control program loaded thereon, and the ECU hardware comprises a communication module, a processor module, a storage module, a drive module and a signal collection module;
the communication module is used for two-way communication with a host computer;
the processor module is used for running the control program;
the storage module is used for storing the control program, data of the perception system and communication information;
the drive module is used for driving each the valve of the active adjustable connecting rod device; and
the signal collection module is used for collecting and feeding back signals of the perception system;
comprising the following steps:
(1) The communication module of the decision making system receives three states of extension, contraction and length fixing of the connecting rod as well as an extension or contraction speed and speed information instructions of the connecting rod from the host computer;
(2) The processor module runs an established program stored in the storage module and decomposes the instructions from the host computer into an on-off, the opening sizes and the switching frequencies of the valves;
(3) The valves are driven by the drive module to work, and the state of the connecting rod is changed;
(4) The perception system collects the real-time state of the connecting rod, and the signal collection module collects the data of the perception system and feeds back the signals of the perception system to the processor module; and
(5) The processor module judges whether the connecting rod has reached the established extension or contraction target, if yes, the adjustment is ended, if not, the steps (2) to (5) are repeated until the established target is reached.

16. The control method according to claim 15, wherein the perception system directly measures change of the connecting rod length through a height sensor arranged on the rod body.

17. The control method according to claim 15, wherein the perception system measures a mass flow of liquid passing through the pipelines using mass flow meters, and due to incompressibility of the liquid, change of the connecting rod length is calculated by the mass flow meters arranged in the storage module in advance and a calculation model for the connecting rod length according to the data measured by the mass flow meters.

18. The control method according to claim 15, wherein the perception system comprises a height sensor and mass flow meters, the height sensor directly measures change of the connecting rod length, mass flow meters measure a mass flow of liquid passing through the pipelines, and due to incompressibility of the liquid, the change of the connecting rod length is calculated by the mass flow meters arranged in the storage module in advance and a calculation model for the connecting rod length according to the data measured by the mass flow meters; information on the change of the connecting rod length is obtained in two manners.

19. The control method according to claim 14 wherein change of the connecting rod length is directly measured by a height sensor, and the change of the connecting rod length is calculated by mass flow meters arranged in a storage module in advance and a calculation model for the connecting rod length according to data of the mass flow meters; a processor module compares the data of the change of the connecting rod length calculated by the mass flow meters with the data of the change of the connecting rod length directly measured by the height sensor, and monitors fullness of the liquid medium in an active device; and if a difference between two sets of data is greater than a preset threshold Δ, it is considered that liquid leakage has occurred, and an ECU sends an alarm message to a host computer.
